(19) United States
(12) Patent Application Publication
(10) Pub. No.: US 2006/0225397 A1
(43) Pub. Date: Oct. 12, 2006

(54) Compactor apparatus with right hand and left hand augers for a cotton module builder and method of operation of the same

(75) Inventors: Frank C. Dupire, Manheim, PA (US); Timothy A. Meeks, Davenport, IA (US); Michael J. Covington, Bettendorf, IA (US)

Correspondence Address: CNH AMERICA LLC, INTELLECTUAL PROPERTY LAW DEPARTMENT, 700 STATE STREET, RACINE, WI, 53404, US

(73) Assignee: CNH America LLC

(21) Appl. No.: 11/095,068

(22) Filed: Mar. 31, 2005

(51) Int. Cl. A01D 43/02

(52) U.S. Cl. 56/341

(57) ABSTRACT

A cotton compacting apparatus and method for a cotton compactor chamber of a cotton module builder or packager, including a frame movable downwardly against cotton for compacting the cotton into a cotton module or package, the frame including at least one auger having a right hand helical flight and at least one auger having a left hand flight, the opposite hand augers being counter-rotatable in a manner for effecting desired movement of cotton within the module builder for building a module having a desired shape and density.

### TECHNICAL FIELD

This invention relates generally to a compactor apparatus and method for compacting and building a cotton module, and more particularly, to compactor apparatus including augers on one side having right hand flights, and augers on another side having left hand flights, the augers being cooperatively operable for distributing cotton in a manner within the chamber which facilitates compaction into a cotton module having a desired shape and density.

### BACKGROUND ART

On a cotton harvester having an onboard cotton module builder, also known as a cotton packager, the module or cotton package is formed by a compactor apparatus or structure that moves in a vertical direction within a module builder or cotton compactor chamber, thereby pressing and compacting the cotton beneath the compactor structure against the chamber floor structure. Typically, augers on the compactor structure distribute the cotton within the compactor chamber and also act as compactor members for applying downward force against the cotton beneath the compactor structure when the compactor structure moves vertically down within the chamber. This results in a generally rectangular shape free-standing module of compacted cotton when subsequently unloaded onto the ground or another surface. Also typically, once unloaded, the top of the module is covered with a canvas or film tarp or cover. This is to prevent water from collecting on the module from rain or condensation prior to processing by a cotton gin. Cotton gins typically cannot process the cotton if the cotton is too high in moisture content. Recent advances in cotton compactor technology have provided the capability to densely pack the cotton, such that the module can substantially retain the shape of the sides of a module builder or compactor chamber, and such that the sides of the module will have a density that will shed water. However, to form a module having a desired consistency throughout, and/or a module top having a desired shape, for instance, a flat shape, a shape tapered or sloped to one side to shed water in one direction, or a crown shape to better shed water in all directions, it must be possible to controllably distribute the cotton in a manner which facilitates achieving such consistency and/or shape.

Thus, what is sought is compactor structure for a cotton module builder capable of densely compacting the cotton to a desired consistency and top shape, yet which overcomes one or more of the problems or shortcomings set forth above.

### SUMMARY OF THE INVENTION

What is disclosed is a cotton compacting apparatus and method for distributing and compacting cotton within a cotton compactor chamber of a cotton module builder or packager, having the capabilities and which overcome the problems and shortcomings set forth above.

According to a preferred aspect of the invention, the compactor apparatus includes a frame adapted to be supported in the chamber for downward movement against cotton collected in a lower portion of the chamber for compacting the cotton therein into a cotton module or package, the frame including a plurality of elongate cotton compactor members disposed in a longitudinally extending array, including at least one auger adjacent to one side of the frame and having one or more right hand helical flights, and another auger adjacent to an opposite side of the frame having one or more left hand helical flights, both augers being rotatable according to steps of a preferred method of the invention, in opposite directions for moving cotton downwardly through the frame and longitudinally and laterally in different directions both above and beneath the frame. More preferably, the right and left hand augers are simultaneously rotated, so as to move the cotton convergingly toward a center region of the chamber. As a result, the cotton is concentrated in the center region, to provide sufficient cotton for compaction into a desired crown shape for shedding moisture.

### BRIEF DESCRIPTION OF THE DRAWINGS

FIG. 1 is a side view of a cotton harvesting machine having an on-board cotton module builder including compactor apparatus according to the present invention for forming a compacted cotton module, the compactor apparatus being shown in a raised position;

FIG. 2 is another side view of the harvesting machine of FIG. 1 showing the compactor apparatus in a lowered, compacting position;

FIG. 3 is a simplified schematic side view of the harvesting machine showing the compactor apparatus in dotted lines and showing right hand and left hand augers thereof;

FIG. 4 is a top view of the compactor apparatus of FIG. 1, showing one arrangement of right hand and left hand augers thereof;

FIG. 5 is a diagramatic representation of operating modes of the augers of FIG. 4;

FIG. 6 is a top view of the compactor apparatus of FIG. 1, showing an alternative arrangement of right hand and left hand augers thereof;

FIG. 7 is a diagramatic representation of operating modes of the augers of FIG. 6;

FIG. 8 is a simplified schematic top view of the compactor apparatus of FIG. 6, illustrating a manner of compaction of cotton thereby;

FIG. 9 is a simplified schematic end view of the cotton module builder of FIG. 1, showing the compactor apparatus of the invention in a lowered position compacting cotton in a bottom region of the module builder;

FIG. 10 is another simplified schematic end view of the cotton module builder of FIG. 1, showing the compactor apparatus of the invention in an uppermost position, and illustrating rotation of augers thereof for distributing cotton within the module builder;

FIG. 11 is another simplified schematic end view of the cotton module builder of FIG. 1, showing the compactor apparatus of the invention in the uppermost position holding cotton above a completed cotton module;

FIG. 12 is an end view of a free standing cotton module built in the module builder of FIG. 1;

FIG. 13 is a top view of the compactor apparatus of FIG. 1, showing another arrangement of right hand and left hand augers;

FIG. 14 is a diagrammatic representation of operating modes of the augers of FIG. 13;

FIG. 15 is a top view of the compactor apparatus of FIG. 1, showing still another alternative arrangement of augers; and

FIG. 16 is a diagrammatic representation of operating modes of the augers of FIG. 15.

### DETAILED DESCRIPTION OF THE INVENTION

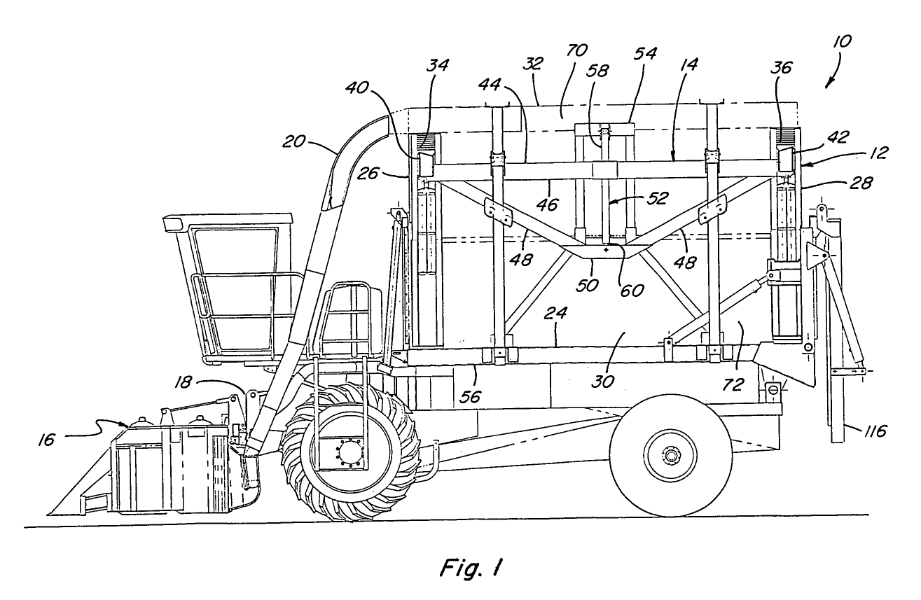

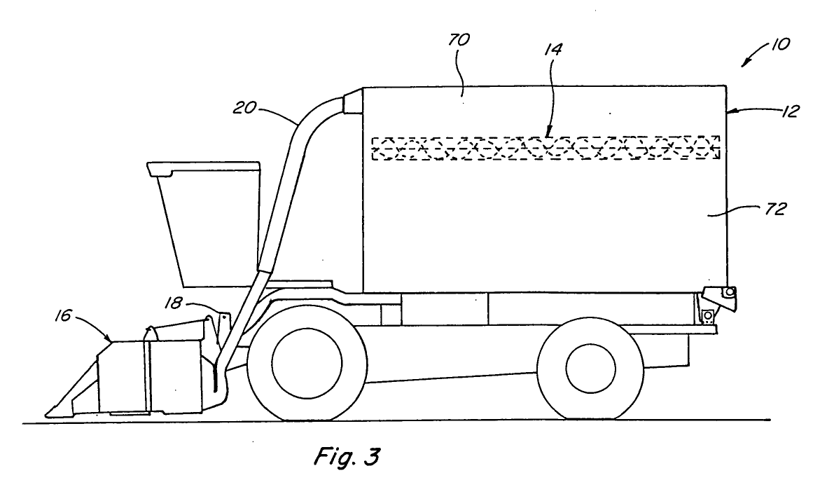

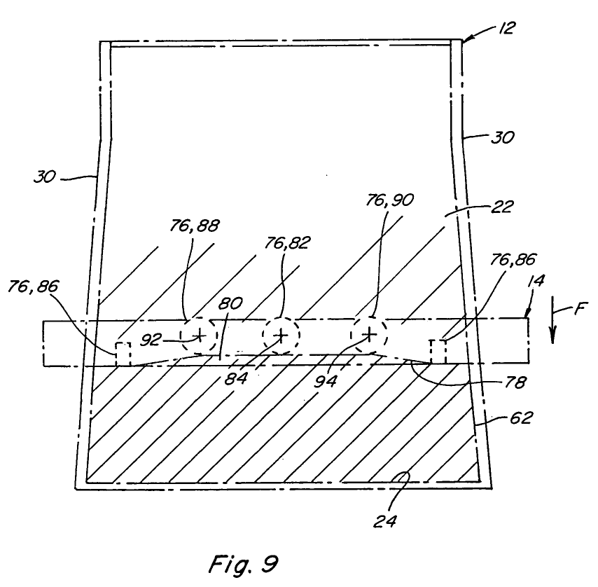

Referring now to the drawings, in FIGS. 1, 2 and 3, a cotton harvesting machine 10 is shown, including an on-board cotton module builder 12, including a compactor apparatus 14 constructed and operable according to preferred aspects of the present invention for compacting and building a cotton module. Generally, cotton harvesting machine 10 is self-propelled for movement over a field of cotton plants, and includes a plurality of cotton harvesting units 16 extending in a side-by-side array across a front end 18 of machine 10. Cotton harvested by harvesting units 16 is conveyed by flows of air through ducts 20 which extend rearwardly and upwardly from harvesting units 16 to an upper region of a cotton compacting chamber 22 (FIGS. 9, 10 and 11) of module builder 12, in the well known conventional manner. The cotton conveyed into cotton compacting chamber 22 will then collect on a floor 24 within chamber 22, against which the cotton will be compacted by compactor apparatus 14, as will be explained.

Cotton compacting chamber 22 is a four-sided cavity defined on the bottom by floor 24 and upwardly extending opposing front and rear end walls 26 and 28, and opposing side walls 30, extending therebetween. Walls 26, 28 and 30 typically include openings or perforations therethrough, to allow passage and dissipation of the air used to convey the cotton into chamber 22, while retaining the cotton therein. The upper region of cotton compacting chamber 22 of module builder 12 is enclosed by a roof 32 which can also include openings or perforations for the passage of air but not significant amounts of cotton therethrough. The side walls 30 each include a vertical forward slot 34 adjacent front end wall 26, and a vertical rearward slot 36 adjacent rear end wall 28, slots 34 and 36 extending substantially the entire vertical height of the compacting chamber.

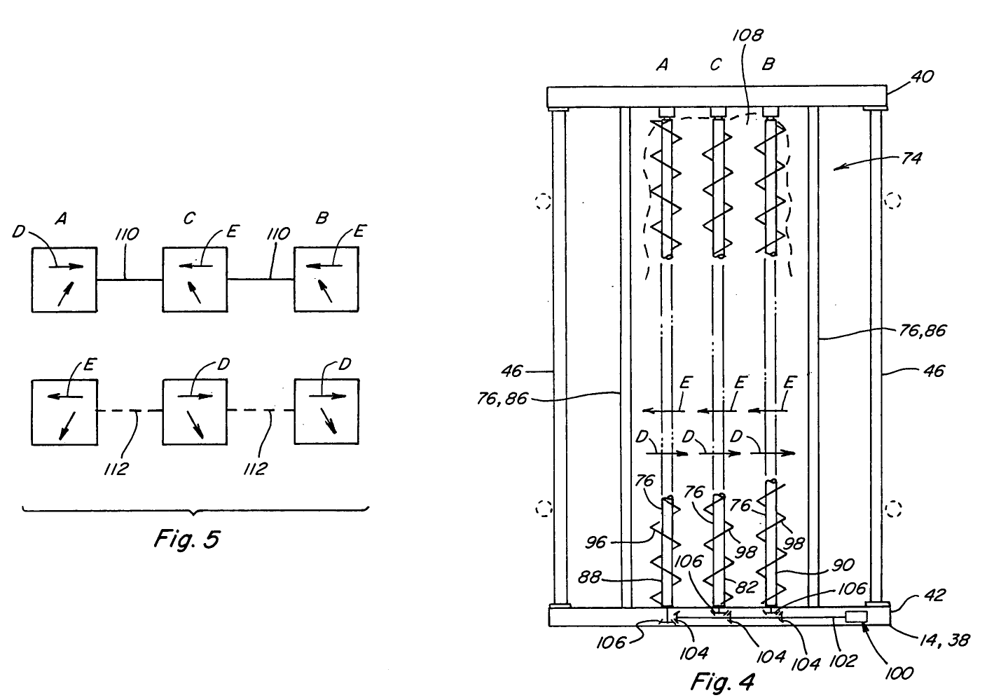

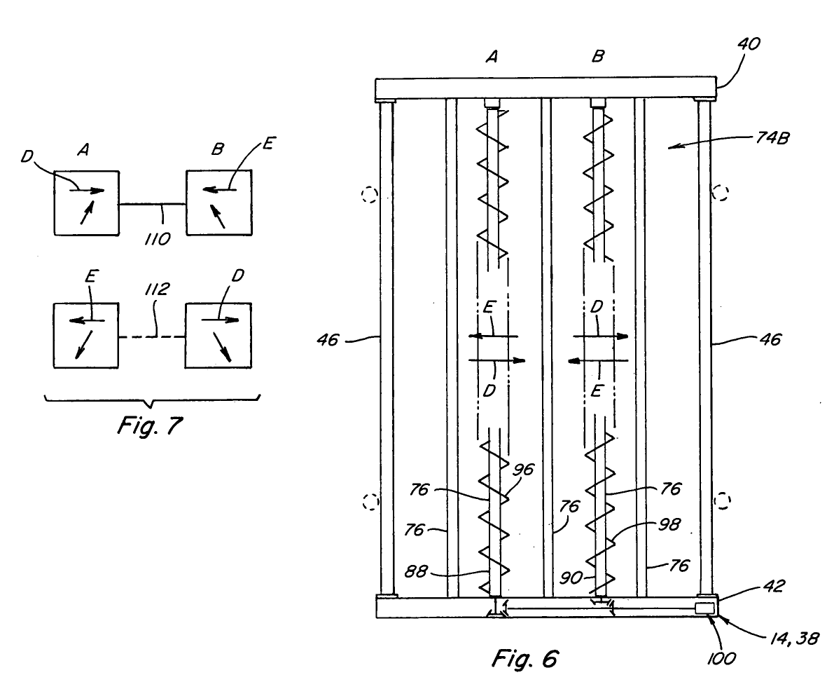

Compactor apparatus 14 of module builder 12 includes a compactor frame 38 which is generally horizontal and substantially entirely disposed within cotton compacting chamber 22, for movement downwardly against cotton contained therein for compacting the cotton against floor 24. Compactor frame 38 (FIGS. 4 and 6) includes a front cross member 40 disposed in chamber 22 adjacent front end wall 26, having opposite ends which extend through slots 34. Similarly, a rear cross member 42 is disposed in chamber 22 adjacent rear end wall 28 and has opposite ends extending through slots 36.

Compactor frame 38 of compactor apparatus 14 is supported in compacting chamber 22 on each side by an exterior side structure 44, each structure 44 including a substantially horizontal, forwardly and rearwardly extending main beam 46 which extends between and connects front and rear cross members 40 and 42. Each side structure 44 additionally includes a pair of braces 48 which extend downwardly and at converging angles from front and rear cross members 40 and 42, and which are connected together by a gusset 50 located spacedly below about the middle of main beam 46. Here, it should be noted that compactor frame 38 (FIG. 4) located within compacting chamber 22 and exterior side structures 44 on the exterior of the side walls represented by side wall 30 are movable upwardly and downwardly together.

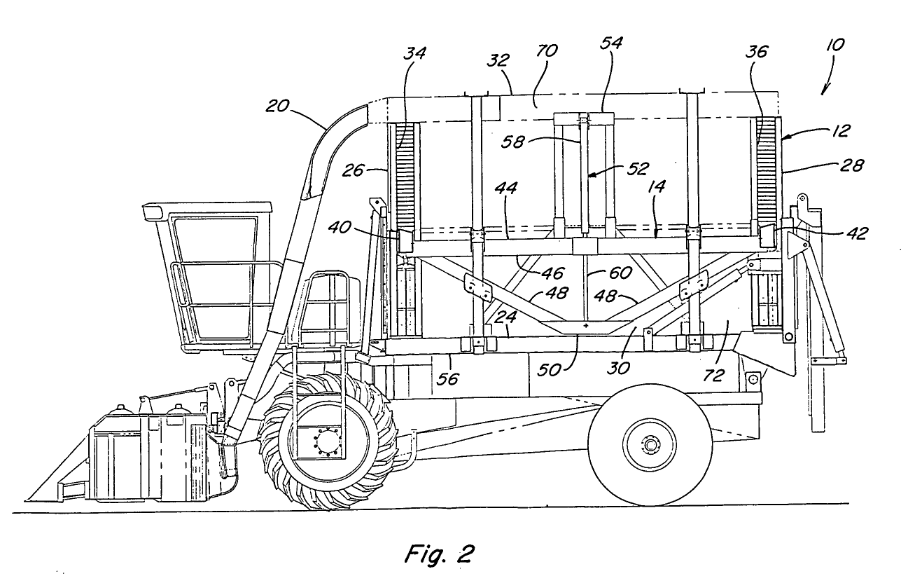

The upward and downward movement of exterior side structures 44 and compactor frame 38 is preferably achieved and controlled by drivers 52 extending, respectively, between gusset 50 of each exterior side structure 44 and a support frame 54 supported by and extending upwardly from a frame 56 of module builder 12. Drivers 52 each preferably comprise a fluid cylinder 58 which receives fluid under pressure from a suitable pressurized fluid source, such as a fluid pump (not shown) of machine 10, for moving exterior side structure 44, and thus compactor frame 38 of compactor apparatus 14, upwardly and downwardly as required or desired for performing a cotton distributing and/or compacting operation. Each fluid cylinder 58 is connected to support frame 54 and includes a rod 60 connected to gusset 50 of exterior side structure 44. In FIG. 1, rod 60 is shown in a retracted position in cylinder 58 such that exterior side structure 44 and compactor frame 38 are located at an elevated or raised position. FIG. 2 shows rod 60 extended to a substantially extended position, to position side structure 44 and compactor frame 38 at a lowered position, representing about a maximum compacting position of compactor apparatus 14. Here, it should be noted that compactor apparatus 14 can be supported and driven by a wide variety of alternative apparatus other than that just disclosed, such as, but not limited to, apparatus including a greater or lesser number of drivers disposed in different positions in connection with the compactor structure. In regard to the next discussion, it should also be noted that the basic shape and/or dimensions of the cotton module builder or packager with which compactor structure is used can vary from that disclosed herein.

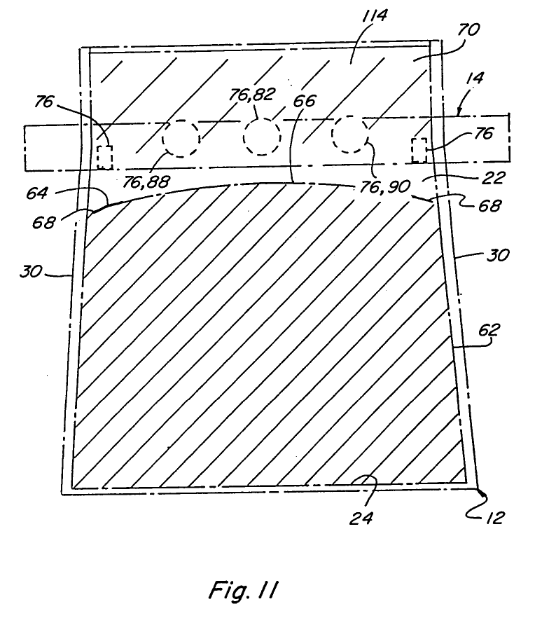

Generally, a cotton module built using module builder 12 will have a generally rectangular or four sided shape when viewed from above which will have a longitudinal extend of about 14 to 18 feet, a transverse extent of from about 6 to 9 feet, and a height of up to about 9 feet. The shape when viewed from above and the longitudinal and transverse dimensions of the module are determined by the corresponding dimensions of cotton compacting chamber 22. Preferably, the cotton modules, as represented by cotton module 62 shown in FIGS. 11 and 12, will have a top surface 64 having a crown 66 at about the center thereof, preferably extending longitudinally in the forward and rearward direction. Top surface 64 will slope downwardly from crown 66 to opposite longitudinally extending side peripheral edges 68 at an angle sufficiently steep such that the module, at least when covered with a fabric or film cover, will be capable of shedding moisture, such as rain water and dew. The height and shape of top surface 64 are preferably consistent from the forward to rearward end, and the sloped portions of top surface 64 can be curved or straight.

As noted above, during the harvesting operation, cotton is conveyed by air flows through ducts 20 into chamber 22. The cotton is discharged into an upper region 70 of chamber 22, above compactor apparatus 14. The cotton must then pass or be conveyed downwardly through compactor apparatus 14 into the lower region 72 of chamber 22, below compactor apparatus 14. Additionally, initially the cotton may not be evenly distributed either forwardly and rearwardly or side to side within upper region 70, and the amount and density of the cotton within region 70 can vary widely, depending on such factors as harvesting rate and the amount of compacting actions done by compactor apparatus 14 within chamber 22. In the former regard, with the advent of six row cotton harvesters, the rate of cotton inflow into upper region 70, particularly under high yield conditions, can be quite high, sufficient for cotton to collect to a significant height above compactor apparatus 14, particularly the rear end, within a relatively short period of time. Augers are provided on compactor apparatus 14, for distributing and transferring this cotton in a desired manner to lower region 72. In the latter regard, the functions of compactor apparatus 14 include activating the augers for distributing the cotton more evenly or as desired within lower region 72, and at times driving compactor apparatus 14 downwardly against the cotton to compress and compact it within lower region 72 and against floor 24, typically with the augers not rotating. Thus, compactor apparatus 14 functions to transfer or convey the cotton from upper region 70 to lower region 72; to distribute the cotton more evenly or in a desired manner within lower region 72; and to compact the cotton in lower region 72 into the compacted cotton module as represented by module 62, including, in this embodiment, so as to have a top surface 64 including a crown 66 extending the length of the middle thereof.

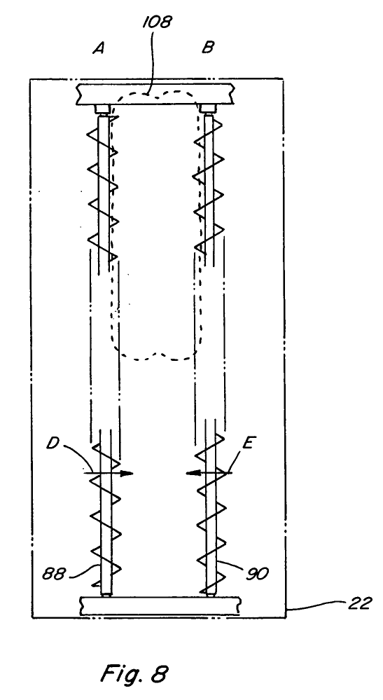

Referring also to FIGS. 4 and 5, construction and operation of one embodiment of a compactor apparatus 14 including three augers is shown including features for performing the functions set forth above. FIGS. 6 and 7 illustrate construction and operation of an alternative two auger embodiment of compactor apparatus 14. Each of the embodiments of compactor apparatus 14 includes a plurality or array 74 of elongate cotton compactor members 76 extending between front cross member 40 and rear cross member 42 at spaced locations between main beams 46. The compactor members 76 of array 74 each include a lower cotton contacting portion for pressing against the cotton in lower region 72 for compacting it when apparatus 14 is driven downwardly by drivers 52 thereagainst. Referring also to FIGS. 9, 10 and 11, the cotton compactor members 76 located between side beams 86 are preferably disposed above side beams 86, to define a longitudinally extending, downwardly facing cavity 80 represented by line 78, for forming crown 66 and the sloped shape on top surface 64 of a cotton module 62 as it is being compacted, as will be explained.

In FIGS. 4, 9, 10 and 11, array 74 of compactor members 76 includes a centrally located longitudinally extending center auger 82 rotatable about an axis of rotation 84 (FIG. 9) extending longitudinally therethrough; opposite side compactor members 76 which comprise longitudinally extending beams 86; and longitudinally extending augers 88 and 90 disposed between center auger 82 and beams 86, and rotatable about rotational axes 92 and 94 (FIG. 9), respectively. Center auger 82 and auger 90 are each right hand augers, that is, they each include a right hand helical flight 98 therearound, and auger 88 is a left hand auger, including a left hand helical flight 96 therearound. Alternatively, for this embodiment, auger 82 could be a left hand auger, if desired. In FIG. 4, auger 88 is also denoted as auger A; auger 90 is denoted as auger B; and auger 82 is denoted as auger C.

Augers 82, 88 and 90 are rotatable by a suitable drive 100, which is illustrated as a gear drive including a drive motor, which can be, for instance, an electric or fluid motor, controllable for rotating an output 102 extending through rear cross member 42 and including bevel gears 104 enmeshed with bevel gears 106 on augers 82, 88 and 90, respectively, for effecting rotation thereof. Alternatively, drive 100 can include an individual drive for each of augers 82, 88 and 90, or, a common drive for right hand augers 82 and 90, and a separate drive for left hand auger 88, as well as other drive arrangements, as desired or required for a particular application. Here, it should be noted that for versatility, and to facilitate a wide range of options for forming a cotton module, each of augers 82, 88 and 90 is desirably rotatable in both a clockwise rotational direction, denoted by arrows D, and a counterclockwise rotational direction, denoted by arrows E. In this regard, by using a common drive, such as drive 100 illustrated, augers 82, 88 and 90 can be rotated simultaneously, with left hand auger 88 being counter-rotated relative to right hand augers 82 and 90. That is, when output 102 is rotated to rotate right hand augers 82 and 90 in clockwise direction D, because of reverse gearing, left hand auger 88 is rotated in counterclockwise direction E. Conversely, when output 102 is rotated for rotating right hand augers 82 and 90 in counterclockwise direction E, auger 88 will be simultaneously rotated in clockwise direction D. It should be noted that FIG. 4 is a top view, looking down on augers 82, 88 and 90, front cross member 40 and thus the front end of compactor apparatus 14 being located at the top of the figure. Additionally, it should be noted that when left hand augers 88 is rotated in clockwise direction D, it will act to pitch or push or convey cotton thereabove and thereon toward the front end of compactor apparatus 14, that is, toward front cross member 40 at the top of FIG. 4, and also to the right. When rotated in direction E, augers 82 and 90 will have a tendency to push the cotton thereabove toward front cross member 40, and at least to some extent, to the left as viewed from above in FIG. 4. When left hand auger 88 is rotated in the counterclockwise direction E, it will convey or push cotton thereon toward the rear and, at least to some extent, to the left. When right hand augers 82 and 90 are rotated in direction D, they will convey cotton thereon to the rear and to the right. In this way, it should be apparent that by the combination of left hand auger 88 and right hand augers 82 and 90, and counter-rotating those opposite hand augers in directions D and E, respectively, collected cotton on and above the augers can be conveyed thereby forwardly and downwardly therethrough to a central, front region of compacting chamber 22, as generally denoted by region 108. This is advantageous, as cotton conveyed through ducts 20 into upper region 70 of chamber 22 of module builder 12, will be typically initially directed more toward the mid and rear portions of upper region 70, and it is anticipated that most of the cotton will therefore desirably be conveyed by augers 82, 88 and 90 into a more mid or rear portion of lower region 72. As a result, for forming a cotton module which is generally uniform front to rear, it will thus be desirable to convey a portion of that cotton forwardly toward region 108.

FIG. 5 is a diagrammatic representation of a matrix of possible directions of rotation of augers 88, 90 and 82, denoted as A, B and C, respectively, and the effective direction of movement of cotton thereon thereby. Arrow D or E in each of the boxes denotes the direction of rotation of the auger, and the diagonal arrow in the box below the arrow D or E denotes the direction in which the cotton on and above the auger will be moved or conveyed thereby. Thus, it can be seen that simultaneous rotation of augers A and B/C in directions D and E, respectively, will result in conveyance of cotton thereon and thereabove generally toward the center and front, that is, toward region 108 in FIG. 4, whereas rotation of those augers in the opposite direction E will convey the cotton thereon more outwardly and rearwardly. The boxes for conveyance of the cotton more forwardly are connected by solid line 110. The boxes for conveyance of the cotton more rearwardly are connected by dotted lines 112. Generally, for building a cotton module having a crown on the top, it is anticipated that it will be desirable to operate the augers mostly in the combination connected by lines 110.

In the embodiment of FIG. 6, array 74 of compactor members includes only augers 88 and 90. Center auger 82 is replaced by a center compactor member 76. Auger 88 again is a left hand auger, that is, it includes a left hand helical flight 96 therearound, and auger 90 is a right hand auger, including a right hand helical flight 98 therearound. Auger 88 is also denoted as auger A and auger 90 is denoted as auger B.

Augers 88 and 90 are counter-rotatable by a suitable common drive such as drive 100 shown, or can be driven by individual drives, as desired or required for a particular application. Here, it should be again noted that for versatility, and to facilitate a wide range of options for forming a cotton module, each of augers 88 and 90 is desirably rotatable in both a clockwise rotational direction, denoted by arrows D, and a counterclockwise rotational direction, denoted by arrows E. Also again, as in FIG. 4, it should be noted that FIG. 6 is a top view, looking down on augers 88 and 90, front cross member 40 and thus the front end of compactor apparatus 14 being located at the top of the figure. Additionally, it should be noted that when left hand auger 88 is rotated in clockwise direction D, it will act to push or convey cotton thereon and thereabove toward the front end of compactor apparatus 14, that is, toward front cross member 40 at the top of FIG. 4. Depending on the angle or pitch of helical flights 96 of auger 88 relative to the longitudinal direction, when rotated in direction D, auger 88 will have a tendency to push the cotton thereon, at least to some extent, to the right as viewed from above. Simultaneously, right hand auger 90 will be rotated in the counterclockwise direction E so as to convey or push cotton thereon toward the front and, at least to some extent, to the left, depending on the pitch or angle of right hand helical flight 98. In this way, it should be apparent that by the combination of left hand augers flights 96 on auger 88, right hand auger flights 98 on auger 90, and counter-rotating those opposite hand augers in directions D and E, respectively, collected cotton on compactor apparatus 14 can be conveyed thereby to a central, front region of compacting chamber 22, as generally denoted by region 108 in FIG. 8, and as is advantageous as discussed above for forming a module having a crown.

FIG. 7 is a diagrammatic representation of a matrix of possible directions of rotation of augers 88 and 90 of the embodiment of FIG. 6, denoted as A and B, respectively. Again, arrow D or E in each of the boxes denotes the direction of rotation of the auger, and the diagonal arrow in the box below the arrow D or E denotes the direction in which the cotton on the auger will be conveyed thereby. Thus, it can be seen that simultaneous counter-rotation of augers A and B in directions D and E, respectively, will result in conveyance of cotton thereon generally toward the center and front, that is, toward region 108 in FIG. 8, whereas counter-rotation of those augers in the opposite directions E and D, respectively, will convey the cotton thereon more outwardly and rearwardly. The boxes for conveyance of the cotton more forwardly are connected by solid line 110. The boxes for conveyance of the cotton more rearwardly are connected by dotted line 112. Again, it is anticipated that the operating combination of line 110 would be mostly used for forming a module having a crown top.

Referring also to FIGS. 9, 10, and 11, steps for building a compacted cotton module, represented by module 62, and including a crown 66 extending longitudinally along about the center of a top surface 64, will be described. In FIG. 9, compactor apparatus 14 is shown at a lowered compacting position within cotton compacting chamber 22 of compactor apparatus 14 for compacting the cotton against floor 24 and side walls 30 of module builder 12. Here, it should be understood that compactor apparatus 14 can be lowered by drivers 52 (FIGS. 1 and 2) so as to contact and extert a force, denoted by arrow F, against the cotton collected on floor 24 sufficient for significantly compacting the cotton. The augers 82, 88 and 90, will typically not be rotated during this compaction step. Due to the existence of concave cavity 80, the desired top surface 64 having a longitudinally extending, central crown 66 and downward slopes to side beams 86, will be formed. Here, it should be noted that these steps can be repeated as desired or required at different elevations within chamber 22 as incoming cotton is incorporated and formed into module 62.

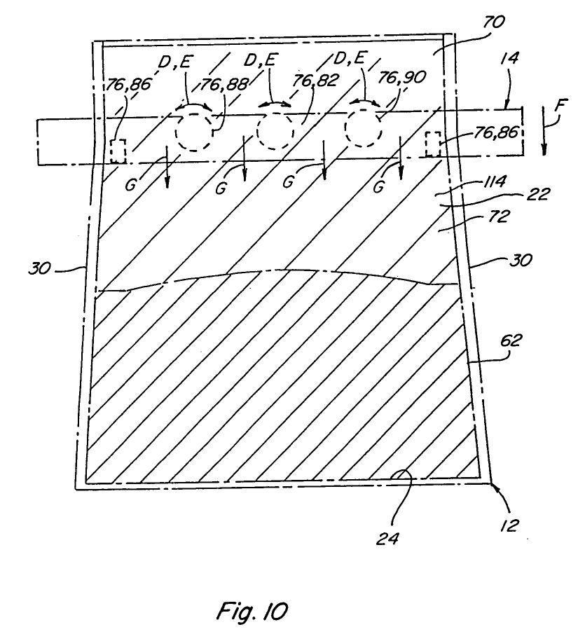

In FIG. 10, partially completed module 62 is located in the lower region of chamber 22 and compactor apparatus 14 is located a spaced distance thereabove, with augers 82, 88 and 90 being rotated, as denoted by arrows D and E, for transferring and distributing loose and incoming cotton 114 (represented by wider cross hatched region) from upper region 70 of chamber 22 downwardly between augers 82, 88 and 90 and beams 86 into lower region 72, denoted by arrows G, over and onto partially formed module 62 (narrower cross hatched) for integration into module 62, when compactor apparatus 14 is driven downwardly, as denoted by arrow F (see FIG. 9).

Referring also to FIG. 11, compactor apparatus 14 is shown in a raised position above a completed compacted cotton module 62, module 62 including a top surface 64 having a center crown 66 and a shape which slopes downwardly therefrom toward peripheral edges 68, along the longitudinal extent of module 62. Loose and incoming cotton 114 (represented by wider cross hatching) is located and accumulating in upper region 70 of chamber 22. By not rotating augers 82, 88 and 90, at least a substantial portion of the incoming cotton will be retained in upper regions 70, to allow unloading of the completed cotton module 62, as shown in FIG. 12.

Here, it should be noted that during the harvesting operation, as cotton is delivered into upper region 70, the augers can be continuously operating, so as to continuously convey and distribute the cotton into the lower region of the chamber and such that the cotton will not collect to a significant extent in the upper region. During such auger operation, the speed and direction of rotation can be varied or alternated as desired or required for obtaining a desired distribution of the cotton in the lower region of the chamber. Then, at times, as required, the compactor apparatus can be lowered with the augers rotating to distribute the collected cotton in a desired or required manner, and the rotation can be stopped as the compactor apparatus is driven downwardly against the cotton to compact it.

Referring also to FIG. 12, completed cotton module 62 is shown removed from chamber 22, the module having been compacted sufficiently so as to be freestanding, and so as to retain top surface 64 having centrally located longitudinally extending crown 66, and slopes extending downwardly to peripheral edges 68. Module 62 will be sufficiently densely compacted and the crown and slope will be such that moisture will not accumulate thereon. Module 62 is now ready to be covered.

Here, in reference to FIGS. 9, 10 and 11, cotton module builder 12 can have longitudinally extending opposite side walls 30 which extend divergingly in the downward direction, such that a completed cotton module such as module 62 will have correspondingly tapered side walls. It should also be noted that side beams 86 of compactor apparatus 14 are positioned so as to be in close proximity to the side walls, respectively, when module 62 is at and near its complete or maximum height, as best shown in FIGS. 10 and 11, such that the cotton will be compacted and shaped between the side walls and beams to form the longitudinally extending side peripheral edges 68 lower than crown 66. It should be further noted that it is anticipated that a completed cotton module will be unloaded from module builder 12 by tilting module builder 12 such that the forward end thereof is raised relative to the rearward end, and that the module will be conveyed over a folding door apparatus 116 (FIG. 1). As a result, it is desirable to retain cotton within upper region 70, with only a minimal amount of the cotton inadvertently being allowed to pass or fall downwardly through compactor apparatus 14 onto the completed module, or into the empty chamber so as to possibly fall or pass from the chamber. Thus, in regard to the spacing between the compactor members of compactor apparatus 14, such spacing should be sufficiently adequate for passage of cotton therethrough when the augers are rotating, but sufficiently small such that cotton can be largely retained by the augers thereabove after completion of a cotton module. As a result, less cotton will be likely to be lost and only a small amount of loose cotton will be present on the top of the module, such that a cover placed on the module will fit snuggly in conformance to the top surface and have few depressions or irregularities where moisture can collect. Because the size and shape of the top surface of the module can be closely controlled as a result of the present invention, covers can be more precisely made to the same size and shape, such that there is less likelihood of wind getting under a loose cover and lifting and fully or partially removing it or damaging it or the underlying cotton.

Alternatively, it should be recognized that the auger arrangement of compactor apparatus 14 can be configured for better distributing cotton therebeneath, that is, the cotton already in lower region 72, as opposed to the cotton thereabove. Two preferred embodiments of auger arrangements for better distributing cotton beneath compactor apparatus 14 are discussed hereinbelow.

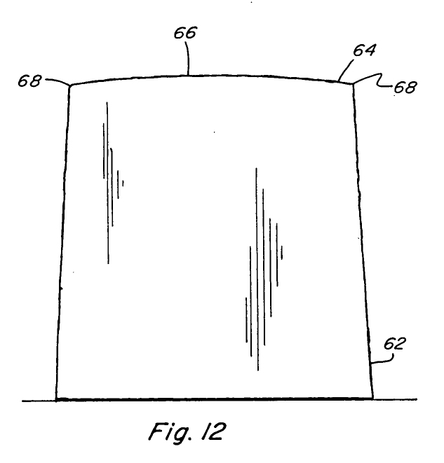

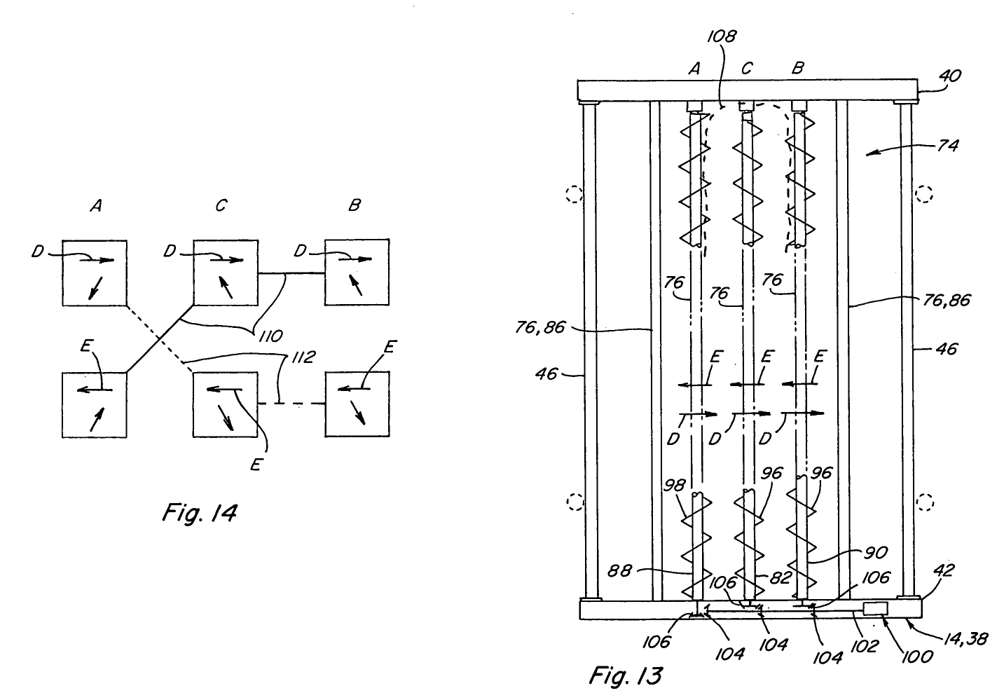

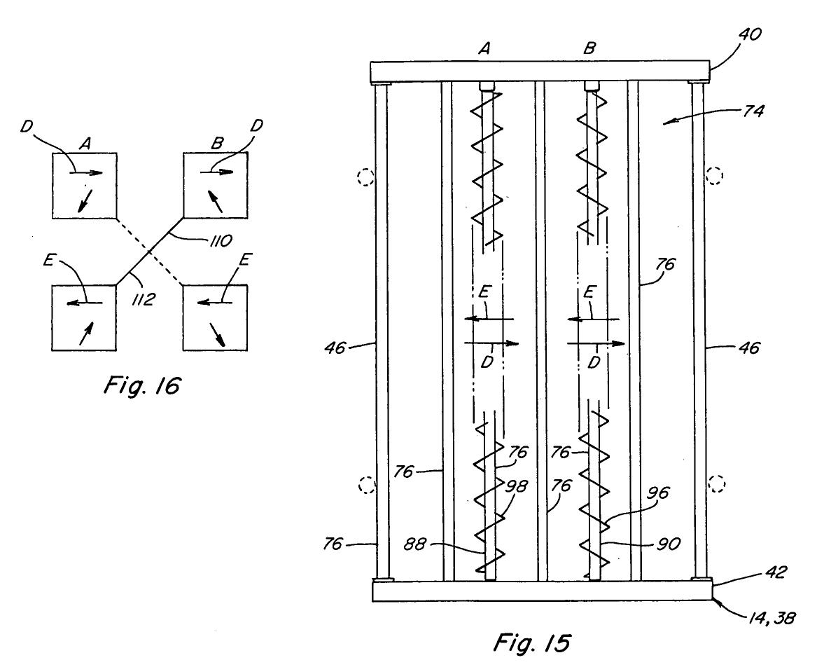

Referring also to FIGS. 13 and 14, construction and operation of another embodiment of a compactor apparatus 14 is shown. FIGS. 15 and 16 illustrate construction and operation of still another alternative embodiment of compactor apparatus 14. Each of the embodiments of compactor apparatus 14 includes a plurality or array 74 of elongate cotton compactor members 76 extending between front cross member 40 and rear cross member 42 at spaced locations between main beams 46. The compactor members 76 of array 74 each include a lower cotton contacting portion for pressing against the cotton in lower region 72 for compacting it when apparatus 14 is driven downwardly by drivers 52 thereagainst.

In FIG. 13, array 74 of compactor members 76 includes a centrally located longitudinally extending center auger 82 rotatable about an axis of rotation extending longitudinally therethrough; opposite side compactor members 76 which comprise longitudinally extending beams 86; and longitudinally extending augers 88 and 90 disposed both horizontally and vertically between center auger 82 and beams 86, and rotatable about longitudinal rotational axes therethrough. Center auger 82 and auger 90 are each left hand augers, that is, they each include a left hand helical flight 96 therearound, and auger 88 is a right hand auger, including a right hand helical flight 98 therearound. This is the opposite of the arrangement of FIG. 4. In FIG. 13, auger 88 is also denoted as auger A; auger 90 is denoted as auger B; and auger 82 is denoted as auger C.

Augers 82, 88 and 90 are rotatable by a suitable drive 100, which again is illustrated as a gear drive including a drive motor, which can be, for instance, an electric or fluid motor, controllable for rotating an output 102 extending through rear cross member 42 and including bevel gears 104 enmeshed with bevel gears 106 on augers 82, 88 and 90, respectively, for effecting rotation thereof. Alternatively, drive 100 can include an individual drive for each of augers 82, 88 and 90, or, a common drive for left hand augers 82 and 90, and a separate drive for right hand auger 88, as well as other drive arrangements, as desired or required for a particular application. Here, it should be noted that for versatility, and to facilitate a wide range of options for forming a cotton module, each of augers 82, 88 and 90 is desirably rotatable in both a clockwise rotational direction, denoted by arrows D, and a counterclockwise rotational direction, denoted by arrows E. In this regard, by using a common drive, such as drive 100 illustrated, augers 82, 88 and 90 can be rotated simultaneously, with right hand auger 88 being counter-rotated relative to left hand augers 82 and 90. That is, when output 102 is rotated to rotate right hand auger 88 in clockwise direction D, because of reverse gearing, left hand augers 82 and 90 are rotated in counterclockwise direction E. Conversely, when output 102 is rotated for rotating auger 88 in counterclockwise direction E, augers 82 and 90 will be simultaneously rotated in clockwise direction. It should be noted that FIG. 13 is a top view, looking down on augers 82, 88 and 90, front cross member 40 and thus the front end of compactor apparatus 14 being located at the top of the figure. Additionally, it should be noted that when left hand augers 82 and 90 are rotated in clockwise direction D, they will act to push or convey cotton therebeneath toward the front end of compactor apparatus 14, that is, toward front cross member 40 at the top of FIG. 13. Depending on the angle or pitch of helical flights 96 of augers 82 and 90 relative to the longitudinal direction, when rotated in direction D, augers 82 and 90 will have a tendency to push the cotton therebeneath, at least to some extent, to the left as viewed from above in FIG. 13. Simultaneously, right hand auger 88 will be rotated in the counterclockwise direction E so as to convey or push cotton therebeneath toward the front and, at least to some extent, to the right, depending on the pitch or angle of right hand helical flights 98. In this way, it should be apparent that by the combination of left hand augers flights 96 on auger 88, right hand auger flights 98 on augers 82 and 90, and counter-rotating those opposite hand augers in directions D and E, respectively, collected cotton beneath compactor apparatus 14 can be conveyed thereby to a central, front region of compacting chamber 22, as generally denoted by region 108. This is advantageous, as cotton conveyed through ducts 20 into upper region 70 of chamber 22 of module builder 12 (FIGS. 1 and 2), will be typically initially directed more toward the mid and rear portions of upper region 70, and it is anticipated that most of the cotton will therefore fall and be conveyed by augers 82, 88 and 90 into a more mid or rear portion of lower region 72. As a result, for forming a cotton module which is generally uniform front to rear, it will thus be desirable to convey a portion of that cotton forwardly toward region 108. This may be done at different elevations in chamber 22, and/or with apparatus 14 in its raised position, as desired or required for achieving a desired distribution of the cotton in chamber 22. For instance, the augers could be operated when apparatus is in a position such as shown in FIG. 9, or any position between that of FIG. 9 and that of FIG. 11.

FIG. 14 is a diagrammatic representation of a matrix of possible directions of rotation of augers 88, 90 and 92, denoted as A, B and C, respectively, and the effective direction of cotton movement thereby. Arrow D or E in each of the boxes denotes the direction of rotation of the auger, and the diagonal arrow in the box below the arrow D or E denotes the direction in which the cotton beneath the auger will be moved or conveyed thereby. Thus, it can be seen that simultaneous counter-rotation of augers A and B/C in directions E and D, respectively, will result in conveyance of cotton therebeneath generally toward the center and front, that is, toward region 108 in FIG. 13, whereas counter-rotation of those augers in the opposite directions, D and E, respectively, will convey the cotton therebeneath more outwardly and rearwardly. The boxes for conveyance of the cotton more forwardly are connected by solid line 110. The boxes for conveyance of the cotton more rearwardly are connected by dotted line 112. Generally, for building a cotton module having a crown on the top, it is anticipated that it will be desirable to operate the augers mostly in the combination connected by line 110.

In the embodiment of FIG. 15, array 74 of compactor members includes only augers 88 and 90. Center auger 82 is replaced by a center compactor member 76. As in the embodiment of FIG. 13, auger 88 again is a right hand auger, that is, it includes a right hand helical flight 98 therearound, and auger 90 is a left hand auger, including a left hand helical flight 96 therearound. Auger 88 is also denoted as auger A and auger 90 is denoted as auger B.

Augers 88 and 90 are counter-rotatable by a suitable common drive such as drive 100 shown in FIG. 13, or can be driven by individual drives, as desired or required for a particular application. Here, it should be again noted that for versatility, and to facilitate a wide range of options for forming a cotton module, each of augers 88 and 90 is desirably rotatable in both a clockwise rotational direction, denoted by arrows D, and a counterclockwise rotational direction, denoted by arrows E. Also again, as in FIG. 13, it should be noted that FIG. 15 is a top view, looking down on augers 88 and 90, front cross member 40 and thus the front end of compactor apparatus 14 being located at the top of the figure. Additionally, it should be noted that when left hand auger 90 is rotated in clockwise direction D, it will act to push or convey cotton therebeneath toward the front end of compactor apparatus 14, that is, toward front cross member 40 at the top of FIG. 15. Depending on the angle or pitch of helical flights 96 of auger 90 relative to the longitudinal direction, when rotated in direction D, auger 90 will have a tendency to push the cotton therebeneath, at least to some extent, to the left as viewed from above. Simultaneously, right hand auger 88 will be rotated in the counterclockwise direction E so as to convey or push cotton therebeneath toward the front and, at least to some extent, to the right, depending on the pitch or angle of right hand helical flight 98. In this way, it should be apparent that by the combination of left hand augers flights 96 on auger 88, right hand auger flights 98 on auger 90, and counter-rotating those opposite hand augers in directions D and E, respectively, collected cotton beneath compactor apparatus 14 can be conveyed thereby to a central, front region of compacting chamber 22, as generally denoted by region 108 in FIG. 13, and as is advantageous as discussed above for forming a module having a crown. Again, this can be done at any position in chamber 22.

FIG. 16 is a diagrammatic representation of a matrix of possible directions of rotation of augers 88 and 90 of the embodiment of FIG. 15, denoted as A and B, respectively. Again, arrow D or E in each of the boxes denotes the direction of rotation of the auger, and the diagonal arrow in the box below the arrow D or E denotes the direction in which the cotton beneath the auger will be conveyed thereby. Thus, it can be seen that simultaneous counter-rotation of augers A and B in directions E and D, respectively, will result in conveyance of cotton therebeneath generally toward the center and front, that is, toward region 108, whereas counter-rotation of those augers in the opposite directions, D and E, respectively, will convey the cotton therebeneath more outwardly and rearwardly. The boxes for conveyance of the cotton more forwardly are connected by solid line 110. The boxes for conveyance of the cotton more rearwardly are connected by dotted line 112. Again, it is anticipated that the operating combination of line 110 would be mostly used for forming a module having a crown top.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

What is claimed is:

1. Apparatus for distributing and compacting cotton within a cotton compactor chamber, comprising:
a frame adapted to be supported in a chamber for downward movement against cotton collected in a lower portion of the chamber for compacting cotton therein into a cotton module, the frame including a plurality of elongate augers rotatable for moving cotton downwardly through the frame and longitudinally along the frame, including at least one right hand auger having at least one right hand helical flight extending longitudinally therearound, and at least one left hand auger having at least one left hand helical flight extending longitudinally therearound.

2. The apparatus of claim 1, wherein the at least one right hand auger is located adjacent to a left side of the frame when viewed from a rear end thereof, and the at least one left hand auger is located adjacent to a right side of the frame when viewed from the rear.

3. The apparatus of claim 2, wherein the frame further includes a center compactor member disposed between the right and left hand augers.

4. The apparatus of claim 3, wherein the center compactor member comprises an elongate, rotatable auger.

5. The apparatus of claim 1, wherein the frame comprises side compactor members located sidewardly outwardly of the augers.

6. The apparatus of claim 1, wherein the a least some of the augers are sufficiently close to elongate compactor members of the frame so as to be capable of holding cotton therebetween, and such that when rotated the augers will convey cotton held thereby downwardly into the compactor chamber below the frame.

7. The apparatus of claim 1, wherein the right hand auger is alternatively rotatable in a first rotational direction and in an opposite second rotational direction.

8. The apparatus of claim 7, wherein the left hand auger is alternatively rotatable in the first rotational direction and in the second rotational direction.

9. The apparatus of claim 1, wherein the right and left hand augers counter-rotate when rotated.

10. Apparatus for distributing and compacting cotton for forming a compacted cotton module, comprising:
a frame supported in a compactor chamber of a cotton packager for downward compacting movement against cotton collected in a bottom portion of the chamber, the frame including elongate side compactor members extending in a predetermined direction along opposite sides of the chamber, respectively, the side compactor members defining a space therebetween extending in the predetermined direction and including lower portions for pressing against any cotton located therebelow during the downward compacting movement for compacting cotton to form peripheral edges of a top surface of a cotton module, and the frame supporting a plurality of elongate augers extending longitudinally in the predetermined direction through the space, the augers including at least one right hand auger located adjacent to one of the side compactor members and having at least one right hand helical flight extending longitudinally therearound, and at least one left hand auger located adjacent to another of the side compactor members and having at least one left hand helical flight extending longitudinally therearound, the right and left hand augers being simultaneously counter-rotatable for moving cotton longitudinally along and through the frame in the predetermined direction and converging toward a center region of the chamber.

11. The apparatus of claim 10, further comprising a center auger supported by the frame, the center auger extending in the predetermined direction through the space between the right and left hand augers.

12. The apparatus of claim 10, wherein the frame further includes a center compactor member disposed between the right and left hand augers.

13. A method for distributing and compacting cotton for forming a compacted cotton module, comprising steps of:
providing a frame supported in a compactor chamber of a cotton packager for downward compacting movement against cotton collected in a bottom portion of the chamber, the frame including elongate side compactor members extending in a predetermined direction along opposite sides of the chamber, respectively, the side compactor members defining a space therebetween extending in the predetermined direction and including lower portions for pressing against any cotton located therebelow during the downward compacting movement for compacting cotton to form peripheral edges of a top surface of a cotton module, and the frame supporting a plurality of elongate augers extending longitudinally in the predetermined direction through the space, the augers including at least one right hand auger located adjacent to one of the side compactor members and having at least one right hand helical flight extending longitudinally therearound, and at least one left hand auger located adjacent to another of the side compactor members and having at least one left hand helical flight extending longitudinally therearound; and
simultaneously rotating the right and left hand augers in opposite rotational directions for moving cotton longitudinally along and through the frame in the predetermined direction and convergingly toward a center region of the chamber.

14. The method of claim 13, comprising an additional step of:
providing a center auger supported by the frame, the center auger extending in the predetermined direction through the space between the right and left hand augers, and rotating the center auger in one of the rotational directions.

15. The method of claim 13, wherein the right and left hand augers are simultaneously rotated in the opposite rotational directions for moving cotton longitudinally beneath the frame in the predetermined direction and convergingly toward a center region of the chamber for collecting cotton in the center region, and then the frame is drivingly moved downwardly against the collected cotton.
